(19) United States
(12) Patent Application Publication
(10) Pub. No.: US 2026/0122622 A1
(43) Pub. Date: Apr. 30, 2026

(54) COMMUNICATION METHOD, AND DEVICE

(71) Applicant: GUANGDONG OPPO MOBILE TELECOMMUNICATIONS CORP., LTD., Dongguan (CN)

(72) Inventor: Jing XU, Dongguan (CN)

(21) Appl. No.: 19/003,979

(22) Filed: Dec. 27, 2024

Related U.S. Application Data
(63) Continuation of application No. PCT/CN2022/119736, filed on Sep. 19, 2022.

(51) Int. Cl. H04W 72/0453; H04W 72/0446; H04W 76/27

(52) U.S. Cl. CPC H04W 72/0453; H04W 72/0446; H04W 76/27

(57) ABSTRACT

A communication method includes: receiving, by a terminal device, configuration information of a first part, the configuration information of the first part being configured for at least one of a bandwidth part (BWP), a cell, or a carrier. The first part is determined based on the configuration information of the first part, a transmission direction of the first part is capable of being different from a transmission direction of a second part, and the first part and the second part are different frequency domain parts of a same time unit

### CROSS-REFERENCE TO RELATED APPLICATIONS

This application is a continuation of International Application No. PCT/CN2022/119736 filed on Sep. 19, 2022, which is incorporated herein by reference.

### TECHNICAL FIELD

The present application relates to the field of communications, and in particular, to a communication method and device.

### BACKGROUND

X division duplexing (XDD) technology has been proposed in the 3rd generation partnership project (3GPP). XDD may also be called time division duplexing or frequency division duplexing. By using XDD technology, data can be sent and received simultaneously on different subbands in the same subframe. However, configuration based on XDD technology may conflict with BWP configuration.

### SUMMARY

Embodiments of the present application provide a communication method, which includes: receiving, by a terminal device, configuration information of a first part, where the configuration information of the first part is configured for at least one of a bandwidth part (BWP), a cell, or a carrier; the first part is determined based on the configuration information of the first part, a transmission direction of the first part is capable of being different from a transmission direction of a second part, and the first part and the second part are different frequency domain parts of a same time unit.

Embodiments of the present application provide a terminal device, which includes: a processor and a memory. The memory is configured to store a computer program, and the processor is configured to call and run the computer program stored in the memory, to cause the terminal device to perform:
receiving configuration information of a first part, where the configuration information of the first part is configured for at least one of a bandwidth part (BWP), a cell, or a carrier; the first part is determined based on the configuration information of the first part, a transmission direction of the first part is capable of being different from a transmission direction of a second part, and the first part and the second part are different frequency domain parts of a same time unit.

Embodiments of the present application provide a network device, which includes: a processor and a memory. The memory is configured to store a computer program, and the processor is configured to call and run the computer program stored in the memory, to cause the network device to perform:
sending configuration information of a first part, where the configuration information of the first part is configured for at least one of a BWP, a cell, or a carrier; and
the first part is determined based on the configuration information of the first part; a transmission direction of the first part is capable of being different from a transmission direction of a second part, and the first part and the second part are different frequency domain parts of a same time unit.

### BRIEF DESCRIPTION OF THE DRAWINGS

FIG. 1 is a schematic diagram of an application scenario, in accordance with embodiments of the present application.

FIG. 2 is a schematic diagram showing a downlink symbol/downlink time slot including an uplink subband, in accordance with embodiments of the present application.

FIG. 3A is a schematic flowchart of a communication method, in accordance with an embodiment of the present application.

FIG. 3B is a schematic flowchart of a communication method, in accordance with another embodiment of the present application.

FIGS. 4A and 4B are schematic diagrams showing a guard sideband, in accordance with embodiments of the present application.

FIG. 5A is a schematic flowchart of a communication method, in accordance with another embodiment of the present application.

FIG. 5B is a schematic flowchart of a communication method, in accordance with another embodiment of the present application.

FIG. 6 is a schematic diagram of a determination process for an uplink part, in accordance with embodiments of the present application.

FIG. 7 is a schematic diagram of Example 1 of a determination process for an uplink part, in accordance with embodiments of the present application.

FIG. 8 is a schematic diagram of TDD system configuration, in accordance with embodiments of the present application.

FIG. 9 is a schematic diagram of Example 2 of a determination process for an uplink part, in accordance with embodiments of the present application.

FIG. 10 is a schematic diagram of Example 3 of a determination process for an uplink part, in accordance with embodiments of the present application.

FIG. 11A is a schematic diagram of an example of uplink part configuration.

FIG. 11B is a schematic diagram of an example of an uplink part for cell or carrier configuration.

FIG. 11C is a schematic diagram of an example of an uplink part for BWP configuration.

FIG. 12 is a schematic block diagram of a terminal device, in accordance with an embodiment of the present application.

FIG. 13 is a schematic block diagram of a network device, in accordance with an embodiment of the present application.

FIG. 14 is a schematic block diagram of a communication device, in accordance with embodiments of the present application.

FIG. 15 is a schematic block diagram of a chip, in accordance with embodiments of the present application.

FIG. 16 is a schematic block diagram of a communication system, in accordance with embodiments of the present application.

### DETAILED DESCRIPTION

Technical solutions in the embodiments of the present application will be described below with reference to the accompanying drawings in the embodiments of the present application.

The technical solutions in the embodiments of the present application may be applied to various communication systems, such as a global system of mobile communication (GSM) system, a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, an non-terrestrial network (NTN) system, a universal mobile telecommunication system (UMTS) system, a wireless local area network (WLAN) system, a wireless fidelity (WiFi) system, a 5th-generation (5G) communication system or other communication systems.

Generally, the limited number of connections is supported by traditional communication systems and is easy to implement. However, with the development of communication technologies, mobile communication systems will not only support traditional communication, but also support, for example, device to device (D2D) communication, machine to machine (M2M) communication, machine type communication (MTC), vehicle to vehicle (V2V) communication, or vehicle to everything (V2X) communication. The embodiments of the present application may also be applied to these communication systems.

In an implementation, the communication system in the embodiments of the present application may be applied to a carrier aggregation (CA) scenario, a dual connectivity (DC) scenario, or a standalone (SA) networking scenario.

In an implementation, the communication system in the embodiments of the present application may be applied to an unlicensed spectrum, which may also be considered as a shared spectrum; or the communication system in the embodiments of the present application may be applied to a licensed spectrum, which may also be considered as an unshared spectrum.

Various embodiments of the present application are described in combination with a network device and a terminal device. The terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus.

The terminal device may be a station (ST) in WLAN, or may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communication system (such as an NR network), or a terminal device in a future evolved public land mobile network (PLMN) network.

In the embodiments of the present application, the terminal device may be deployed on land including indoor or outdoor, handheld, wearable or vehicle-mounted; or the terminal device may be deployed on water (e.g., on a ship); or the terminal device may be deployed in the air (e.g., on an airplane, a balloon, a satellite, etc.).

In the embodiments of the present application, the terminal device may be a mobile phone, a pad, a computer with a wireless transceiving function, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, or the like.

By way of example and not limitation, in the embodiments of the present application, the terminal device may also be a wearable device. The wearable device, which may also be referred to as a wearable smart device, is a generic term of devices that are developed by intelligent design on daily wears using a wearable technology and can be worn, such as glasses, gloves, watches, clothing, or shoes. The wearable device is a portable device that is worn directly on the body or integrated into a user's clothing or accessories. The wearable device not only is a hardware device, but also implements powerful functions through software support as well as data interaction or cloud interaction. Generalized wearable smart devices include devices that have full functions and large sizes, and may implement complete or partial functions without relying on smart phones, such as smart watches or smart glasses, and include devices that focus on a certain type of application functions only and need to be used in combination with other devices (such as smart phones), such as various smart bracelets or smart jewelries for monitoring physical signs.

In the embodiments of the present application, the network device may be a device for communicating with a mobile device. The network device may be an access point (AP) in WLAN, a base station (Base Transceiver Station, BTS) in GSM or CDMA, or a base station (NodeB, NB) in WCDMA; or the network device may be an evolutional base station (Evolutional Node B, eNB or eNodeB) in LTE, a relay station or access point, a network device (gNB) in a vehicle-mounted device, a wearable device or an NR network, a network device in a future evolved PLMN network, or a network device in an NTN network.

By way of example and not limitation, in the embodiments of the present application, the network device may have a mobile characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station disposed on land or in water.

In the embodiments of the present application, the network device may provide services for a cell, and the terminal device may communicate with the network device through transmission resources (e.g., frequency domain resources or spectrum resources) used by the cell. The cell may be a cell corresponding to the network device (e.g., a base station). The cell may belong to a macro base station or a base station corresponding to small cells. Here, the small cells may include a metro cell, a micro cell, a pico cell, a femto cell, etc. These small cells have characteristics of small coverage and low transmission power, and are suitable for providing high-speed data transmission services.

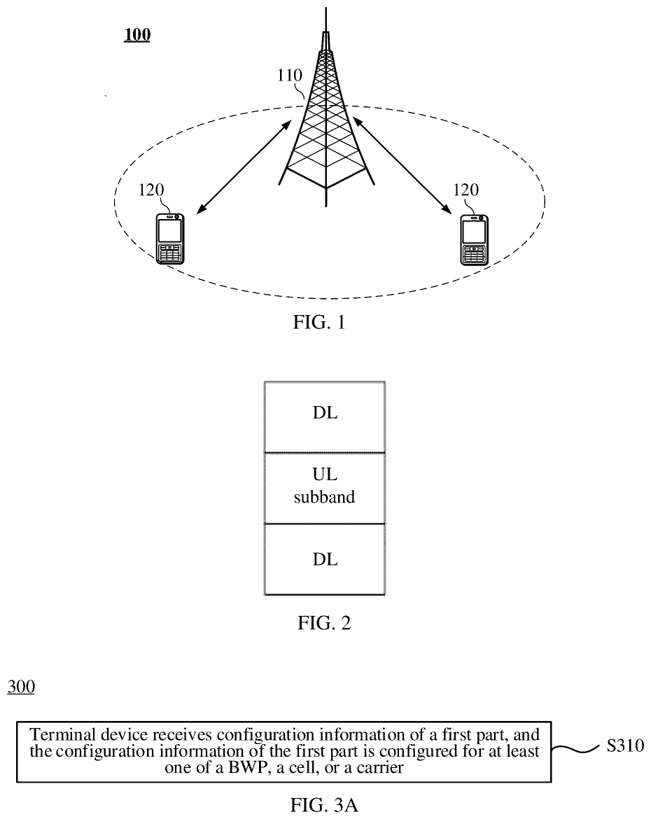

FIG. 1 exemplarily shows a communication system 100. The communication system includes a network device 110 and two terminal devices 120. In an implementation, the communication system 100 may include multiple network devices 110, and another number of terminal devices 120 may be included in coverage of each network device 110, which is not limited in the embodiments of the present application.

In an implementation, the communication system 100 may further include other network entities, such as a mobility management entity (MME), an access and mobility management function (AMF), which is not limited in the embodiments of the present application.

Network devices may include an access network device and a core network device. That is, a wireless communication system further includes multiple core networks for communicating with access network devices. The access network device may be an evolutional base station (evolutional node B, shorted for eNB or e-NodeB), a macro base station, a micro base station (also called a “small base station”), a pico base station, an access point (AP), a transmission point (TP) or a new generation Node B (gNodeB) in a long-term evolution (LTE) system, a next-generation system (mobile communication system) (next radio, NR) or an authorized auxiliary access long-term evolution (LAA-LTE) system.

It should be understood that, in the embodiments of the present application, a device with a communication function in a network/system may be referred to as a communication device. In an example of the communication system shown in FIG. 1, the communication devices may include network device(s) with the communication function and terminal devices with the communication function. The network device and the terminal device may be specific devices in the embodiments of the present application, which will not be repeated here. The communication devices may further include other devices in the communication system, such as a network controller, a mobility management entity and other network entities, which is not limited in the embodiments of the present application.

It should be understood that the terms “system” and “network” are often used interchangeably herein. Herein, the term “and/or” is only a description of an association relationship of associated objects, and indicates that three relationships may exist. For example, A and/or B may mean three situations that: A exists alone, both A and B exist, and B exists alone. Moreover, the character “/” herein generally indicates that the associated objects before and after this character are in an “or” relationship.

It should be understood that “indicate” mentioned in the embodiments of the present application may mean a direct indication or an indirect indication, or may represent that there is an association relationship. For example, that A indicates B may mean that A directly indicates B, e.g., that B may be obtained through A; or it may mean that A indirectly indicates B, e.g., that A indicates C, and B may be obtained through C; or it may mean that there is an association relationship between A and B.

The term “correspond” described in the embodiments of the present application may represent a direct or indirect correspondence between the two, or an association relationship between the two, or mean a relationship such as indicating and being indicated, or configuring and being configured.

To facilitate understanding of the technical solutions in the embodiments of the present application, following technologies in the embodiments of the present application are described. The following technologies, as optional solutions, may be arbitrarily combined with the technical solutions in the embodiments of the present application, and those combined solutions all fall within protection scope of the embodiments of the present application.

### I. Uplink and Downlink Configuration

For a time division duplexing (TDD) system, the uplink and downlink configuration is used to configure/indicate a transmission direction of each symbol. Generally, one or more of three ways, namely time division duplexing uplink and downlink common configuration (TDD-UL-DL-ConfigCommon), time division duplexing uplink and downlink dedicated configuration (TDD-UL-DL-ConfigDedicated) and slot format indicator (SFI), are used to indicate a transmission direction of each symbol. Transmission directions may generally include uplink, downlink, and flexible types. TDD-UL-DL-ConfigCommon and TDD-UL-DL-ConfigDedicated are high-level signaling and are configured for a cell; and the former is sent to all users in the cell through broadcast information, and the latter is sent independently to users in need through radio resource control (RRC) signaling. SFI indicates the transmission direction of each symbol of each carrier through downlink control information (DCI) of the user group, which may also be referred to as group common DCI.

An exemplary time division duplexing uplink and downlink common configuration information element (TDD-UL-DL-ConfigCommon information element) is as follows:

| | |
|---|---|
| TDD-UL-DL-ConfigCommon ::= | SEQUENCE { |
| referenceSubcarrierSpacing | SubcarrierSpacing, |
| pattern1 | TDD-UL-DL-Pattern, |
| pattern2 | TDD-UL-DL-Pattern |

OPTIONAL, -- Need R
...
}

| | |
|---|---|
| TDD-UL-DL-Pattern ::= | SEQUENCE { |
| dl-UL-TransmissionPeriodicity | ENUMERATED {ms0p5, ms0p625, ms1, |

ms1p25, ms2, ms2p5, ms5, ms10},

| | |
|---|---|
| nrofDownlinkSlots | INTEGER (0..maxNrofSlots), |
| nrofDownlinkSymbols | INTEGER (0..maxNrofSymbols-1), |
| nrofUplinkSlots | INTEGER (0..maxNrofSlots), |
| nrofUplinkSymbols | INTEGER (0..maxNrofSymbols-1), |

```
  ...,
  [[
```

| | |
|---|---|
| dl-UL-TransmissionPeriodicity-v1530 | ENUMERATED {ms3, ms4} |

OPTIONAL -- Need R
]]
}

An exemplary time division duplexing uplink and downlink dedicated configuration information element (TDD-UL-DL-ConfigDedicated information element) is as follows:

| | |
|---|---|
| TDD-UL-DL-ConfigDedicated ::= | SEQUENCE { |
| slotSpecificConfigurationsToAddModList | SEQUENCE (SIZE |
| (1..maxNrofSlots)) OF TDD-UL-DL-SlotConfig | OPTIONAL, -- Need N |
| slotSpecificConfigurationsToReleaseList | SEQUENCE (SIZE |
| (1..maxNrofSlots)) OF TDD-UL-DL-SlotIndex | OPTIONAL, -- Need N |

...
}

| | |
|---|---|
| TDD-UL-DL-SlotConfig ::= | SEQUENCE { |
| slotIndex | TDD-UL-DL-SlotIndex, |
| symbols | CHOICE { |
| allDownlink | NULL, |
| allUplink | NULL, |
| explicit | SEQUENCE { |
| nrofDownlinkSymbols | INTEGER |

(1..maxNrofSymbols-1)

| | |
|---|---|
| nrofUplinkSymbols | INTEGER |

```
(1..maxNrofSymbols-1)
    }
  }
}
```

| | |
|---|---|
| TDD-UL-DL-SlotIndex ::= | INTEGER (0..maxNrofSlots-1) |

### II. Bandwidth Part (BWP) Configuration

The BWP configuration is configured to indicate transmission frequency domain resources, subcarrier spacing, and information of various channels. Examples of various channels include: a physical downlink shared channel (PDSCH), a physical downlink control channel (PDCCH), a physical uplink control channel (PUCCH), a physical uplink shared channel (PUSCH), a random access channel (RACH), and a channel related to semi-persistent scheduling (SPS). The BWP configuration may be a parameter in the cell configuration (which is also referred to as cell configuration information). For example, if a cell can be configured with a maximum of 4 BWPs, a BWP to be used by the terminal device can be indicated in a semi-static or dynamic manner. Dynamic indication manners include timer-based switching and DCI indication.

### 1. UL Subband in DL Symbol/Slot

TDD is mainly used on the base station side. The terminal device side still maintains the current state (that is, only data transmission or reception is supported within a subframe). For example, as shown in FIG. 2, in a non-overlapping subband full duplex or subband non-overlapping full duplex (SBFD) subframe, a middle subband of a downlink time slot may be configured as an uplink subband.

However, the configuration method for the uplink part is still unclear. Since both the uplink and downlink configuration and the uplink part configuration are used to indicate the transmission direction, one method is that the uplink part configuration adopts a method similar to the uplink and downlink configuration (that is, the uplink part configuration is configured for the cell as a parameter in the cell configuration). However, the BWP configuration in parallel with the uplink part configuration may flexibly configure the bandwidth used for transmission in the cell, so that there may be a conflict between a frequency domain bandwidth of the BWP configuration and a frequency domain bandwidth of the uplink part configuration. For example, the frequency domain bandwidth of the uplink part configuration is greater than the frequency domain bandwidth of the BWP configuration, which brings implementation complexity.

The communication method provided in the embodiments of the present application may include an uplink part configuration method, to solve the problem of the conflict between the uplink part configuration and the BWP configuration.

Embodiments of the present application provides a communication method, which includes:
receiving, by a terminal device, configuration information of a first part, the configuration information of the first part being configured for at least one of a bandwidth part (BWP), a cell, or a carrier;
where the first part is determined based on the configuration information of the first part, a transmission direction of the first part is capable of being different from a transmission direction of a second part, and the first part and the second part are different frequency domain parts of a same time unit.

In some embodiments of the present application, the configuration information of the first part includes frequency domain configuration information of the first part and/or time domain configuration information of the first part.

In some embodiments of the present application, frequency domain configuration information of the first part is configured for the BWP, and the frequency domain configuration information of the first part is configured in BWP configuration information; and/or
time domain configuration information of the first part is configured for the BWP, and the time domain configuration information of the first part is configured in the BWP configuration information.

In some embodiments of the present application, the BWP configuration information includes uplink BWP configuration information and/or downlink BWP configuration information, and the configuration information of the first part is configured in the uplink BWP configuration information and/or the downlink BWP configuration information.

In some embodiments of the present application, the configuration information of the first part is configured in BWP common configuration information or BWP user dedicated configuration information.

In some embodiments of the present application, subcarrier spacing used by the first part is determined by the uplink BWP configuration information or the downlink BWP configuration information; and/or
a cyclic prefix used by the first part is determined by the uplink BWP configuration information or the downlink BWP configuration information.

In some embodiments of the present application, subcarrier spacing in the uplink BWP configuration information is same as subcarrier spacing in the downlink BWP configuration information; and/or a cyclic prefix in the uplink BWP configuration information is same as a cyclic prefix in the downlink BWP configuration information.

In some embodiments of the present application, an indication manner of frequency domain configuration information of the first part includes a resource indication value (RIV), a bitmap or a count.

In some embodiments of the present application, a bandwidth of the first part is within a bandwidth of the BWP.

In some embodiments of the present application, the method further includes:
receiving, by the terminal device, guard sideband configuration information, where a position of guard sideband(s) is determined based on the guard sideband configuration information, and the guard sideband(s) is/are located on one side or both sides of the first part.

In some embodiments of the present application, in a case where guard sidebands are located on both sides of the first part, bandwidths of the guard sidebands on both sides of the first part are same or different.

In some embodiments of the present application, in a case where there are downlink transmission resources on both sides of the first part within a carrier, a guard sideband is located between the first part and a downlink transmission resource, and a number of resource blocks (RBs) of each of the guard sidebands on both sides of the first part is same.

In some embodiments of the present application, in a case where there is a downlink transmission resource on only one side of the first part within a carrier, a guard sideband is located between the first part and the downlink transmission resource.

In some embodiments of the present application, frequency domain configuration information of the first part is applicable to at least one of the following:
all first time slots;
all first symbols;
a first time slot including the first part, agreed upon by a protocol;
a first symbol including the first part, agreed upon by a protocol;
a configured first time slot including the first part; or
a configured first symbol including the first part.

In some embodiments of the present application, the first time slot includes a downlink time slot or a flexible time slot, and the first symbol includes a downlink symbol or a flexible symbol.

In some embodiments of the present application, frequency domain configuration information of the first part is configured for the cell or the carrier; and/or
time domain configuration information of the first part is configured for the cell or the carrier.

In some embodiments of the present application, subcarrier spacing used by the first part is determined by activated uplink BWP configuration information or downlink BWP configuration information; and/or
a cyclic prefix used by the first part is determined by the activated uplink BWP configuration information or downlink BWP configuration information.

In some embodiments of the present application, a frequency domain position of the first part is obtained based on at least one of the following:
frequency domain configuration information of the first part in BWP configuration information; or
frequency domain configuration information in the BWP configuration information and frequency domain configuration information of the first part.

In some embodiments of the present application, in a case where the first part is configured, configuration of the BWP needs to meet at least one of the following:
that the BWP only supports semi-static configuration, and a bandwidth of the BWP includes a bandwidth of the first part; or
that bandwidths of all BWPs include a bandwidth of the first part.

In some embodiments of the present application, the first part includes an uplink part or a downlink part.

Embodiments of the present application provides a communication method, which includes:
sending, by a network device, configuration information of a first part, the configuration information of the first part being configured for at least one of a BWP, a cell, or a carrier;
where the first part is determined based on the configuration information of the first part, a transmission direction of the first part is capable of being different from a transmission direction of a second part, and the first part and the second part are different frequency domain parts of a same time unit.

In some embodiments of the present application, the configuration information of the first part includes frequency domain configuration information of the first part and/or time domain configuration information of the first part.

In some embodiments of the present application, frequency domain configuration information of the first part is configured for the BWP, and the frequency domain configuration information of the first part is configured in BWP configuration information; and/or
time domain configuration information of the first part is configured for the BWP, and the time domain configuration information of the first part is configured in the BWP configuration information.

In some embodiments of the present application, the BWP configuration information includes uplink BWP configuration information and/or downlink BWP configuration information, and the configuration information of the first part is configured in the uplink BWP configuration information and/or the downlink BWP configuration information.

In some embodiments of the present application, the configuration information of the first part is configured in BWP common configuration information or BWP user dedicated configuration information.

In some embodiments of the present application, subcarrier spacing used by the first part is determined by the uplink BWP configuration information or the downlink BWP configuration information; and/or
a cyclic prefix used by the first part is determined by the uplink BWP configuration information or the downlink BWP configuration information.

In some embodiments of the present application, subcarrier spacing in the uplink BWP configuration information is same as subcarrier spacing in the downlink BWP configuration information; and/or a cyclic prefix in the uplink BWP configuration information is same as a cyclic prefix in the downlink BWP configuration information.

In some embodiments of the present application, an indication manner of frequency domain configuration information of the first part includes a resource indication value (RIV), a bitmap or a count.

In some embodiments of the present application, a bandwidth of the first part is within a bandwidth of the BWP.

In some embodiments of the present application, the method further includes:
sending, by the network device, guard sideband configuration information, where a position of guard sideband(s) is determined based on the guard sideband configuration information, and the guard sideband(s) is/are located on one side or both sides of the first part.

In some embodiments of the present application, in a case where guard sidebands are located on both sides of the first part, bandwidths of the guard sidebands on both sides of the first part are same or different.

In some embodiments of the present application, in a case where there are downlink transmission resources on both sides of the first part within a carrier, a guard sideband is located between the first part and a downlink transmission resource, and a number of resource blocks (RBs) of each of the guard sidebands on both sides of the first part is same.

In some embodiments of the present application, in a case where there is a downlink transmission resource on only one side of the first part within a carrier, a guard sideband is located between the first part and the downlink transmission resource.

In some embodiments of the present application, frequency domain configuration information of the first part is applicable to at least one of the following:
all first time slots;
all first symbols;
a first time slot including the first part, agreed upon by a protocol;
a first symbol including the first part, agreed upon by a protocol;
a configured first time slot including the first part; or
a configured first symbol including the first part.

In some embodiments of the present application, the first time slot includes a downlink time slot or a flexible time slot, and the first symbol includes a downlink symbol or a flexible symbol.

In some embodiments of the present application, frequency domain configuration information of the first part is configured for the cell or the carrier; and/or
time domain configuration information of the first part is configured for the cell or the carrier.

In some embodiments of the present application, subcarrier spacing used by the first part is determined by activated uplink BWP configuration information or downlink BWP configuration information; and/or
a cyclic prefix used by the first part is determined by the activated uplink BWP configuration information or downlink BWP configuration information.

In some embodiments of the present application, a frequency domain position of the first part is obtained based on at least one of the following:
frequency domain configuration information of the first part in BWP configuration information; or
frequency domain configuration information in the BWP configuration information and frequency domain configuration information of the first part.

In some embodiments of the present application, in a case where the first part is configured, configuration of the BWP needs to meet at least one of the following:
that the BWP only supports semi-static configuration, and a bandwidth of the BWP includes a bandwidth of the first part; or
that bandwidths of all BWPs include a bandwidth of the first part.

In some embodiments of the present application, the first part includes an uplink part or a downlink part.

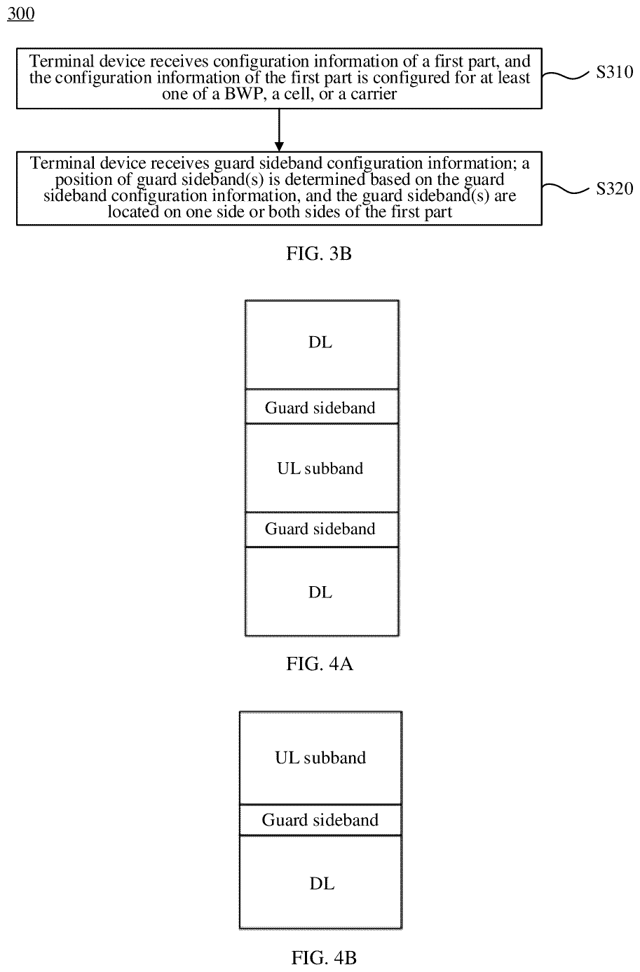

FIG. 3A is a schematic flow chart of a communication method 300, in accordance with an embodiment of the present application. The method may optionally be applied to a terminal device in the system shown in FIG. 1, but is not limited thereto. The method includes at least part of the following.

In S310, the terminal device receives configuration information of a first part, and the configuration information of the first part is configured for at least one of a bandwidth part (BWP), a cell, or a carrier.

The first part is determined based on the configuration information of the first part, a transmission direction of the first part is capable of being different from a transmission direction of a second part, and the first part and the second part are different frequency domain parts of a same time unit. That is, the transmission direction of the first part is allowed to be different from the transmission direction of the second part, and the transmission direction of the first part is also allowed to be the same as the transmission direction of the second part. Optionally, signaling may be used for the configuration.

In the embodiments of the present application, the terminal device may receive the configuration information of the first part from a network device or another terminal device. For example, if the configuration information of the first part is configured for the BWP, the configuration information of the first part may be carried in BWP configuration information. For another example, if the configuration information of the first part is configured for the cell or the carrier, the configuration information of the first part may be carried in the uplink and downlink configuration information.

In an implementation, the first part may be an uplink part. For example, if the transmission direction of the second part is a downlink direction, the transmission direction of the first part may be an uplink direction.

In an implementation, the first part may be a downlink part. For example, if the transmission direction of the second part is an uplink direction, the transmission direction of the first part may be a downlink direction.

In the embodiments of the present application, the same time unit where the first part and the second part are located may be the same time slot, the same symbol, the same subframe, the same sub-slot, or the like.

In the embodiments of the present application, the first part is mainly used as an uplink part for introduction and illustration. For a case where the first part is a downlink part, reference may be made to the relevant description of the uplink part.

In an implementation, the configuration information of the first part includes frequency domain configuration information of the first part and/or time domain configuration information of the first part.

In an implementation, the frequency domain configuration information of the first part is configured for BWP, and the frequency domain configuration information of the first part is configured in the BWP configuration information; and/or
the time domain configuration information of the first part is configured for BWP, and the time domain configuration information of the first part is configured in the BWP configuration information.

In one case, the frequency domain configuration information of the first part is configured for BWP, and the time domain configuration information of the first part is configured for the cell or the carrier. In another case, the frequency domain configuration information and the time domain configuration information of the first part are both configured for BWP. In yet another case, the frequency domain configuration information and the time domain configuration information of the first part are both configured for the cell or the carrier.

In some embodiments, the terminal device may receive, from a network device or another terminal device, BWP configuration information carrying frequency domain configuration information of the first part; and the terminal device may also receive, from a network device or another terminal device, uplink and downlink configuration information carrying the time domain configuration information of the first part.

In some other embodiments, the terminal device may receive, from a network device or another terminal device, BWP configuration information carrying frequency domain configuration information of the first part and time domain configuration information of the first part.

In yet some other embodiments, the terminal device may receive, from a network device or another terminal device, uplink and downlink configuration information carrying frequency domain configuration information of the first part and time domain configuration information of the first part.

In an implementation, the BWP configuration information includes uplink BWP configuration information and/or downlink BWP configuration information, and the configuration information of the first part is configured in the uplink BWP configuration information and/or the downlink BWP configuration information.

In an implementation, the configuration information of the first part is configured in BWP common configuration information or BWP user dedicated configuration information.

In the embodiments of the present application, the uplink BWP configuration information may include BWP uplink common configuration information (e.g., a BWP-UplinkCommon information element), and may also include BWP uplink dedicated configuration information (e.g., a BWP-UplinkDedicated information element). The downlink BWP configuration information may include BWP downlink common configuration information (e.g., the BWP-DownlinkCommon information element), and may also include BWP downlink dedicated configuration information (e.g., the BWP-DwnlinkDedicated information element). In the BWP uplink common configuration information, the BWP uplink dedicated configuration information, the BWP downlink common configuration information or the BWP downlink dedicated configuration information, the frequency domain configuration information of the uplink part may include an uplink subband, and the time domain configuration information of the uplink part may include a time slot where the uplink subband is located. Similarly, in this information, the frequency domain configuration information of the downlink part may include a downlink subband, and the time domain configuration information of the downlink part may include a time slot downlink subband.

In an implementation, subcarrier spacing used by the first part is determined by or based on the uplink BWP configuration information or the downlink BWP configuration information. For example, the subcarrier spacing used by the first part may be directly determined by subcarrier spacing in the uplink BWP configuration information or the downlink BWP configuration information. For another example, the subcarrier spacing used by the first part may also be indirectly determined by the uplink BWP configuration information or the downlink BWP configuration information. In this way, it may be possible to prevent interference between subcarriers.

In an implementation, a cyclic prefix used by the first part is determined by the uplink BWP configuration information or the downlink BWP configuration information. For example, the cyclic prefix used by the first part may be directly determined by a cyclic prefix in the uplink BWP configuration information or the downlink BWP configuration information. For another example, the cyclic prefix used by the first part may be indirectly determined by the uplink BWP configuration information or the downlink BWP configuration information. In this way, it may be possible to prevent interference between subcarriers.

In an implementation, subcarrier spacing in the uplink BWP configuration information is the same as subcarrier spacing in the downlink BWP configuration information; and/or a cyclic prefix in the uplink BWP configuration information is the same as a cyclic prefix in the downlink BWP configuration information.

In some embodiments, if the configuration information of the uplink part is configured in the BWP uplink common configuration information, the subcarrier spacing used by the uplink part is determined by the subcarrier spacing in the BWP uplink common configuration information, and the cyclic prefix used by the uplink part is determined by the cyclic prefix in the BWP uplink common configuration information. In this case, the subcarrier spacing in the BWP uplink common configuration information may be the same as the subcarrier spacing in the BWP downlink common configuration information, and the cyclic prefix in the BWP uplink common configuration information may be the same as the cyclic prefix in the BWP downlink common configuration information. In this way, inter-subcarrier interference and/or inter-symbol interference may be avoided.

In some other embodiments, if the configuration information of the uplink part is configured in the BWP downlink common configuration information, the subcarrier spacing used by the uplink part is determined by the subcarrier spacing in the BWP downlink common configuration information, and the cyclic prefix used by the uplink part is determined by the cyclic prefix in the BWP downlink common configuration information.

In yet some other embodiments, if the configuration information of the downlink part is configured in the BWP uplink common configuration information, the subcarrier spacing used by the downlink part is determined by the subcarrier spacing in the BWP uplink common configuration information, and the cyclic prefix used by the downlink part is determined by the cyclic prefix in the BWP uplink common configuration information.

In yet some other embodiments, if the configuration information of the downlink part is configured in the BWP downlink common configuration information, the subcarrier spacing used by the downlink part is determined by the subcarrier spacing in the BWP downlink common configuration information, and the cyclic prefix used by the downlink part is determined by the cyclic prefix in the BWP downlink common configuration information. In this case, the subcarrier spacing in the BWP downlink common configuration information may be the same as the subcarrier spacing in the BWP uplink common configuration information, and the cyclic prefix in the BWP downlink common configuration information may be the same as the cyclic prefix in the uplink BWP configuration information. In this way, inter-subcarrier interference and/or inter-symbol interference may be avoided.

The BWP uplink common configuration information in the above examples may be replaced with the BWP downlink common configuration information, BWP uplink dedicated configuration information or BWP downlink dedicated configuration information. Accordingly, the BWP downlink common configuration information may be replaced with the BWP uplink common configuration information, BWP downlink dedicated configuration information or BWP uplink dedicated configuration information. Therefore, the examples are not repeated.

In an implementation, an indication manner of the frequency domain configuration information of the first part includes a resource indication value (RIV), a bitmap or a count.

For example, the frequency domain configuration information of the uplink part may indicate a section of continuous RB resources in a RIV manner. The RIV indication value may be obtained by the indicated starting RB and the number of RBs.

In an implementation, a bandwidth of the first part is within a bandwidth of BWP. Alternatively, the bandwidth of the first part does not exceed the bandwidth of BWP. Alternatively, the bandwidth of the first part is less than or equal to the bandwidth of BWP. For example, the bandwidth of the uplink part indicated by RIV is less than or equal to the bandwidth of the BWP.

In an implementation, as shown in FIG. 3B, the method 300 further includes the following step.

In S320, the terminal device receives guard sideband configuration information, where a position of guard sideband(s) is determined based on the guard sideband configuration information, and the guard sideband(s) is/are located on one side or both sides of the first part.

In the embodiments of the present application, the guard sideband may also be referred to as a guard band, a guard frequency band, or a guard frequency range. The terminal device may receive the guard sideband configuration information from the network device. The guard sideband configuration information and the configuration information of the first part may be carried through the same information or through different information. If the guard sideband configuration information and the configuration information of the first part are received respectively through different information, the receiving timing is not limited. The position of the guard sideband(s) is related to the position of the first part, and may be located on one side or both sides of the first part. For example, as shown in FIG. 4A, if the first part is the uplink part, the guard sidebands may be located on both sides of the uplink part (i.e., the uplink subband). For another example, as shown in FIG. 4B, if the first part is the uplink part, the guard sideband may be located on one side of the uplink part (i.e., the uplink subband).

In an implementation, in the case where the guard sidebands are located on both sides of the first part, bandwidths of the guard sidebands on both sides of the first part are the same or different. For example, if the first part is the uplink part, the number of RBs of each of the guard sidebands on both sides of the uplink part may be the same or different.

In an implementation, in a case where there are downlink transmission resources (e.g., downlink frequency domain resources) on both sides of the first part within a carrier, the guard sidebands each are located between the first part and a downlink transmission resource, and the number of resource blocks (RBs) of each of the guard sidebands on both sides of the first part is the same.

In a case where the uplink subband configured by the frequency domain configuration information of the first part is located in the middle of the carrier, downlink transmission resources may exist on both sides of the first part within the carrier. For example, referring to FIG. 4A, the first part is the uplink subband, which is located between two downlink transmission resources (marked as DL), and there is one guard sideband on each of both sides of the uplink subband. The two guard sidebands may have the same number of RBs.

In an implementation, in a case where there is a downlink transmission resource on only one side of the first part within a carrier, the guard sideband is located between the first part and the downlink transmission resource. For example, referring to FIG. 4B, there is a downlink transmission resource (DL) on one side of the uplink subband in a carrier, and there is no downlink transmission resource on the other side of the uplink subband in the carrier, the guard sideband is located between the uplink subband and the downlink transmission resource (DL).

In an implementation, the frequency domain configuration information of the first part is applicable to at least one of the following:
all first time slots;
all first symbols;
a first time slot including the first part, agreed upon by a protocol;
a first symbol including the first part, agreed upon by a protocol;
a configured first time slot including the first part; or
a configured first symbol including the first part.

In an implementation, the above time slot or symbol may also be replaced with a subframe, a sub-slot, or a half-slot.

In an implementation, if the first part is an uplink part, the first time slot and/or the first symbol is determined based on at least one of the following:
an uplink subband (ULsubband) indicated by the frequency domain configuration information of the uplink part; or
a time slot where the uplink subband is located (SlotULsubband) indicated by the time domain configuration information of the uplink part.

In an implementation, if the first part is a downlink part, the first time slot and/or the first symbol is determined based on at least one of the following:
a downlink subband indicated by the frequency domain configuration information of the downlink part; or
a time slot where the downlink subband is located indicated by the time domain configuration information of the downlink part.

In an implementation, the first time slot includes a downlink time slot or a flexible time slot, and the first symbol includes a downlink symbol or a flexible symbol.

In an implementation, the frequency domain configuration information of the first part is configured for a cell or a carrier; and/or the time domain configuration information of the first part is configured for the cell or the carrier.

For example, the frequency domain configuration information and the time domain configuration information of the uplink part are both configured for the cell or the carrier.

For another example, the frequency domain configuration information of the uplink part is configured for BWP, and the time domain configuration information of the uplink part is configured for the cell or the carrier.

In an implementation, the subcarrier spacing used by the first part is determined by activated uplink BWP configuration information or downlink BWP configuration information. For example, the subcarrier spacing used by the first part is directly determined by the subcarrier spacing in the activated uplink BWP configuration information or downlink BWP configuration information. For another example, the subcarrier spacing used by the first part is indirectly determined by the activated uplink BWP configuration information or downlink BWP configuration information.

In an implementation, the cyclic prefix used by the first part is determined by activated uplink BWP configuration information or downlink BWP configuration information. For example, the cyclic prefix used by the first part is directly determined by the cyclic prefix in the activated uplink BWP configuration information or downlink BWP configuration information. For another example, the cyclic prefix used by the first part is indirectly determined by the activated uplink BWP configuration information or downlink BWP configuration information.

For example, in a case where the first part is uplink, if other parts except the first part are downlink, the subcarrier spacing/cyclic prefix is determined by the activated downlink BWP configuration information; if other parts except the first part are uplink, the subcarrier spacing/cyclic prefix is determined by the activated uplink BWP configuration information; and if other parts except the first part are flexible, the subcarrier spacing/cyclic prefix is determined by the activated downlink BWP configuration information.

For another example, in a case where the first part is downlink, if other parts except the first part are uplink, the subcarrier spacing/cyclic prefix is determined by the activated uplink BWP configuration information; if other parts except the first part are downlink, the subcarrier spacing/cyclic prefix is determined by the activated downlink BWP configuration information; and if other parts except the first part are flexible, the subcarrier spacing/cyclic prefix is determined by the activated uplink BWP configuration information.

In an implementation, a frequency domain position of the first part is obtained based on at least one of the following:
frequency domain configuration information of the first part in the BWP configuration information; or
frequency domain configuration information in the BWP configuration information and the frequency domain configuration information of the first part.

For example, if the frequency domain configuration information of the uplink part is in the BWP configuration information, the frequency domain position of the uplink part may be determined by using the frequency domain configuration information of the uplink part in the BWP configuration information. In this way, it may be possible to reduce the conflict between frequency domain positions of the uplink part determined by using the BWP configuration information and by frequency domain configuration information of another manner.

For another example, if the frequency domain configuration information of the uplink part is not in the BWP configuration information, the frequency domain configuration information in the BWP configuration information and the frequency domain configuration information of the uplink part may be compared to determine which frequency domain configuration information of the uplink part is finally used to determine the frequency domain position of the uplink part. In this way, it may be possible to reduce the conflict between frequency domain positions of the uplink part determined by using the BWP configuration information and by frequency domain configuration information of another manner.

In an implementation, in a case where the terminal device is configured with the first part, the configuration of BWP needs to meet at least one of the following:
that BWP only supports semi-static configuration, and a bandwidth of BWP includes a bandwidth of the first part; or
that bandwidths of all BWPs include a bandwidth of the first part.

In some embodiments, the bandwidth of BWP may be obtained based on the BWP configuration information. If BWP only supports semi-static configuration instead of dynamic configuration, the bandwidth change in the BWP configuration information can be reduced. The bandwidth of BWP is configured to include the bandwidth of the first part, which may reduce the conflict between bandwidths of the BWP configuration information and the uplink and downlink configuration information, and achieve simple implementation. The bandwidth of BWP may also be referred to as a frequency domain configuration bandwidth of BWP. The bandwidth of the first part may also be referred to as a frequency domain configuration bandwidth of the first part.

In some other embodiments, if the bandwidth of BWP configured in the BWP configuration information is greater than or equal to the bandwidth of the first part configured in the uplink and downlink information, or the bandwidth of the first part is within the bandwidth of BWP, the conflict between bandwidths of the BWP configuration information and the uplink and downlink configuration information may also be reduced, and achieve simple implementation.

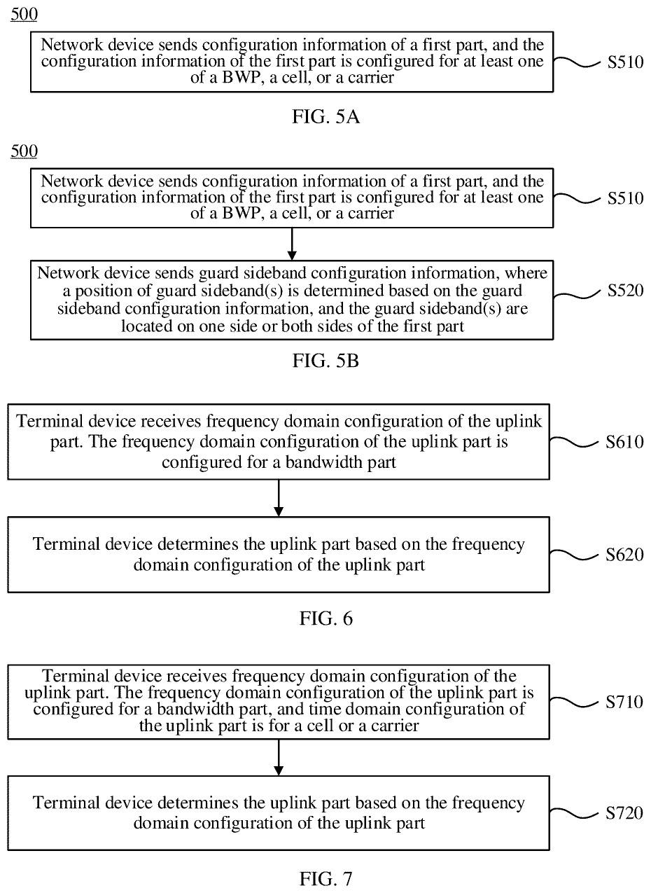

FIG. 5A is a schematic flow chart of a communication method 500, in accordance with an embodiment of the present application. The method may optionally be applied to the network device in the system shown in FIG. 1, but is not limited thereto. The method includes at least part of the following.

In S510, a network device sends configuration information of a first part, and the configuration information of the first part is configured for at least one of a BWP, a cell, or a carrier.

The first part is determined based on the configuration information of the first part; a transmission direction of the first part is capable of being different from a transmission direction of a second part, and the first part and the second part are different frequency domain parts of a same time unit.

In an implementation, the method may further include: determining, by the network device, configuration information of the first part.

In an implementation, the configuration information of the first part includes frequency domain configuration information of the first part and/or time domain configuration information of the first part.

In an implementation, the frequency domain configuration information of the first part is configured for BWP, and the frequency domain configuration information of the first part is configured in BWP configuration information; and/or the time domain configuration information of the first part is configured for BWP, and the time domain configuration information of the first part is configured in the BWP configuration information.

In an implementation, the BWP configuration information includes uplink BWP configuration information and/or downlink BWP configuration information, and the configuration information of the first part is configured in the uplink BWP configuration information and/or the downlink BWP configuration information.

In an implementation, the configuration information of the first part is configured in BWP common configuration information or BWP user dedicated configuration information.

In an implementation, subcarrier spacing used by the first part is determined by the uplink BWP configuration information or the downlink BWP configuration information; and/or a cyclic prefix used by the first part is determined by the uplink BWP configuration information or the downlink BWP configuration information.

In an implementation, subcarrier spacing in the uplink BWP configuration information is the same as subcarrier spacing in the downlink BWP configuration information; and/or a cyclic prefix in the uplink BWP configuration information is the same as a cyclic prefix in the downlink BWP configuration information.

In an implementation, an indication manner of the frequency domain configuration information of the first part includes a resource indication value (RIV), a bitmap or a count.

In an implementation, a bandwidth of the first part is within a bandwidth of BWP.

In an implementation, as shown in FIG. 5B, the communication method 500 further includes the following step.

In S520, the network device sends guard sideband configuration information, where a position of guard sideband(s) is determined based on the guard sideband configuration information, and the guard sideband(s) is/are located on one side or both sides of the first part. Here, S510 and S520 may have no timing restrictions.

In an implementation, in a case where the guard sidebands are located on both sides of the first part, bandwidths of the guard sidebands on both sides of the first part are the same or different.

In an implementation, in a case where there are downlink transmission resources on both sides of the first part within a carrier, the guard sidebands each are located between the first part and a downlink transmission resource, and the number of resource blocks (RBs) of each of the guard sidebands on both sides of the first part is the same.

In an implementation, in a case where there is a downlink transmission resource on only one side of the first part within a carrier, the guard sideband is located between the first part and the downlink transmission resource.

In an implementation, the frequency domain configuration information of the first part is applicable to at least one of the following:
all first time slots;
all first symbols;
a first time slot including the first part, agreed upon by a protocol;
a first symbol including the first part, agreed upon by a protocol;
a configured first time slot including the first part; or
a configured first symbol including the first part.

In an implementation, the first time slot includes a downlink time slot or a flexible time slot, and the first symbol includes a downlink symbol or a flexible symbol.

In an implementation, the frequency domain configuration information of the first part is configured for a cell or a carrier; and/or the time domain configuration information of the first part is configured for the cell or the carrier.

In an implementation, the subcarrier spacing used by the first part is determined by activated uplink BWP configuration information or downlink BWP configuration information; and/or the cyclic prefix used by the first part is determined by activated uplink BWP configuration information or downlink BWP configuration information.

In an implementation, a frequency domain position of the first part is obtained based on at least one of the following:
the frequency domain configuration information of the first part in the BWP configuration information; or
frequency domain configuration information in the BWP configuration information and the frequency domain configuration information of the first part.

In an implementation, in a case where the first part is configured, the configuration of BWP needs to meet at least one of the following:
that BWP only supports semi-static configuration, and a bandwidth of BWP includes a bandwidth of the first part; or
that bandwidths of all BWPs include a bandwidth of the first part.

In an implementation, the first part includes the uplink part or the downlink part.

In an application scenario, as shown in FIG. 6, a determination process for the uplink part may include the following steps.

In S610, the terminal device receives frequency domain configuration of the uplink part. The frequency domain configuration of the uplink part is configured for a bandwidth part. Optionally, the terminal device may receive the frequency domain configuration of the uplink part from a network device.

Furthermore, the frequency domain configuration of the uplink part is a parameter of the bandwidth part. When the bandwidth part changes, the frequency domain configuration of the uplink part also changes accordingly. Furthermore, the frequency domain configuration of the uplink part is configured only in downlink bandwidth part configuration, or is configured only in uplink bandwidth part configuration, or is configured in both the downlink bandwidth part configuration and the uplink bandwidth part configuration.

Furthermore, a bandwidth of the uplink part is less than or equal to a bandwidth of a corresponding bandwidth part.

Furthermore, the bandwidth part includes frequency domain configuration of one or more uplink parts. In a case where the bandwidth part includes only frequency domain configuration of one uplink part, the frequency domain configuration of the uplink part is always effective for the bandwidth part. In a case where the bandwidth part includes configuration of a plurality of uplink parts, a frequency domain configuration of one uplink part in frequency domain configurations of the plurality of uplink parts is indicated based on a MAC layer control element (MAC CE) or DCI.

Furthermore, the terminal device receives guard sideband configuration. Guard sideband(s) are located on one or both sides of the uplink part. If the guard sidebands are located on both sides of the uplink part, bandwidths of the guard sidebands on the both sides of the uplink part may be the same or different.

In S620, the terminal device determines the uplink part based on the frequency domain configuration of the uplink part.

In this example, if the frequency domain configuration of the uplink part is configured for BWP, and the time domain configuration of the uplink part is configured for a cell, the uplink part may adapt to dynamic BWP bandwidth change and cell-level uplink and downlink configuration.

The communication method in the embodiments of the present application is applicable to any link from a base station to a terminal device, from a terminal device to a base station, or between terminal devices.

### Example 1: Semi-Statically Configure the Uplink Part Bandwidth, as Shown in FIG. 7

In S710, the terminal device receives frequency domain configuration of the uplink part. The frequency domain configuration of the uplink part is configured for a bandwidth part, and time domain configuration of the uplink part is for a cell or a carrier. Optionally, the terminal device may receive configuration for BWP including the frequency domain configuration of the uplink part from a network device.

Furthermore, the frequency domain configuration of the uplink part is a parameter of the bandwidth part. For example, the frequency domain configuration of the uplink part (e.g., an uplink subband (UL subband)) may indicate a section of continuous resource block (RB) resources in a resource indication value (RIV) manner. The RIV indication value is obtained by the indicated starting RB and the number of RBs. Alternatively, a bitmap is used to indicate the uplink subband.

Furthermore, the UL subband indicated by RIV is within the bandwidth part. That is, the bandwidth of the UL subband is less than or equal to the bandwidth of the bandwidth part.

Furthermore, the frequency domain configuration of the uplink part is a common configuration parameter for cells. For example, the frequency domain configuration of the uplink part (e.g., the UL subband) may be a parameter in the bandwidth part uplink common parameters (BWP-UplinkCommon), or the frequency domain configuration of the uplink part is a parameter in the bandwidth part downlink common parameters (BWP-DownlinkCommon), or a parameter in BWP.

The following are some examples of an uplink subband (i.e., UL subband-r18) in BWP basic parameters, BWP downlink common parameters, and BWP uplink common parameters.

| | |
|---|---|
| BWP ::= | SEQUENCE { |
| locationAndBandwidth | INTEGER (0..37949), |
| subcarrierSpacing | SubcarrierSpacing, |
| cyclicPrefix | ENUMERATED { extended } |
| UL subband-r18 | INTEGER (0..37949) |

}

| | |
|---|---|
| BWP-DownlinkCommon ::= | SEQUENCE { |
| genericParameters | BWP, |
| pdcch-ConfigCommon | SetupRelease |

{ PDCCH-ConfigCommon }

| | |
|---|---|
| pdsch-ConfigCommon | SetupRelease { PDSCH-ConfigCommon } |
| UL subband-r18 | INTEGER (0..37949) |

.......
}

| | |
|---|---|
| BWP-UplinkCommon ::= | SEQUENCE { |
| genericParameters | BWP, |
| rach-ConfigCommon | SetupRelease |

{ RACH-ConfigCommon }

| | |
|---|---|
| pusch-ConfigCommon | SetupRelease |

{ PUSCH-ConfigCommon }

| | |
|---|---|
| UL subband-r18 | INTEGER (0..37949) |

.......
}

Since the seamless bidirectional forwarding detection (SBFD) operation is performed on the base station side, the division of the uplink part and the downlink part is usually directly related to the radio frequency implementation of the base station. The unified configuration is adopted by the entire cell, which may reduce the implementation complexity of the base station side.
(a) In a case where the UL subband is configured in BWP-UplinkCommon, the subcarrier spacing (subcarrierSpacing) and/or cyclic prefix (cyclicPrefix) used by the uplink part may be determined by subcarrierSpacing and/or cyclicPrefix in BWP-UplinkCommon, respectively. Furthermore, the subcarrier spacing (subcarrierSpacing) and/or cyclic prefix (cyclicPrefix) used by the uplink part are the same as subcarrierSpacing and/or cyclicPrefix in BWP-DownlinkCommon, respectively, which ensures time-frequency synchronization when the uplink and downlink occur in the same symbol. The subcarrier spacing (subcarrierSpacing) and/or cyclic prefix (cyclicPrefix) used by the uplink part may also be configured by subcarrierSpacing and/or cyclicPrefix dedicated to the UL subband.
(b) In a case where the UL subband is configured in BWP-DownlinkCommon, subcarrierSpacing and/or cyclicPrefix used by the uplink part are determined by subcarrierSpacing and/or cyclicPrefix in BWP-DownlinkCommon, respectively.

Of course, in order to adapt to the bandwidth capabilities and service requirements of different terminal devices, the uplink part may also be user dedicated configuration parameter. For example, the uplink part configuration (e.g., UL subband) may be a parameter in the BWP uplink dedicated parameters (BWP-UplinkDedicated), or the uplink part configuration may be a parameter in the BWP uplink dedicated parameters (BWP-DownlinkDedicated).

| | |
|---|---|
| BWP-DownlinkDedicated ::= | SEQUENCE { |
| pdcch-Config | SetupRelease { PDCCH-Config } |
| pdsch-Config | SetupRelease { PDSCH-Config } |
| sps-Config | SetupRelease { SPS-Config } |
| UL subband-r18 | INTEGER (0..37949) |

......
}

| | |
|---|---|
| BWP-UplinkDedicated ::= | SEQUENCE { |
| pucch-Config | SetupRelease { PUCCH-Config } |
| pusch-Config | SetupRelease { PUSCH-Config } |
| UL subband-r18 | INTEGER (0..37949) |

.....
}

When the BWP configuration changes, the uplink part configuration also changes accordingly. The uplink part configuration takes effect at the same time as the BWP configuration. For example, the terminal device receives two BWP configurations (e.g., a first BWP-UplinkDedicated and a second BWP-UplinkDedicated), and each BWP-UplinkDedicated includes a UL subband. If the terminal device indicates the first BWP-UplinkDedicated, the terminal device determines the uplink part according to the UL subband in the first BWP-UplinkDedicated. If the terminal device indicates the second BWP-UplinkDedicated, the terminal device determines the uplink part according to the UL subband in the second BWP-UplinkDedicated.

Furthermore, the terminal device receives the guard sideband configuration (e.g., guard band(s)). Guard sideband(s) is/are located on one or both sides of the uplink part. If the guard sidebands are located on both sides of the uplink part, bandwidths of the guard sidebands on both sides of the uplink part may be the same or different. The guard band may be just the number of RBs, or includes the starting RB and the number of RBs. In a case where the guard band only includes the number of RBs, the guard band is adjacent to the UL subband by default. In a case where the UL subband is located in the middle of the carrier, the guard bands are applied to both sides of the UL subband, and the number of RBs of each of the guard bands on both sides is the same. In a case where the UL subband is located on one side of the carrier, the guard band is applied to the side of the UL subband close to the center frequency. Alternatively, two guard bands are configured to be applied to both sides of the UL subband, respectively.

In S720, the terminal device determines the uplink part based on the frequency domain configuration of the uplink part.
(a) If the UL subband is configured only in BWP-UplinkCommon, in the downlink time slot/symbol and/or flexible time slot/symbol, the uplink part is determined according to the UL subband configuration in BWP-UplinkCommon.
(b) If the UL subband is configured only in BWP-DownlinkCommon, in the downlink time slot/symbol and/or flexible time slot/symbol, the uplink part is determined according to the UL subband configuration in BWP-DownlinkCommon.
(c) If the UL subband is configured in BWP-DownlinkCommon and BWP-UplinkCommon, in the downlink time slot/symbol, the uplink part is determined according to the UL subband configuration in BWP-DownlinkCommon; and in the flexible time slot/symbol, the uplink part is determined according to the UL subband configuration in BWP-UplinkCommon.

Furthermore, BWP-UplinkCommon and BWP-DownlinkCommon may be replaced by BWP-UplinkDedicated and BWP-DownlinkDedicated.

Furthermore, the frequency domain configuration of the uplink part is applicable to all downlink time slots/symbols and/or flexible time slots/symbols, or available downlink time slot(s)/symbol(s) and/or flexible time slot(s)/symbol(s) agreed upon by a protocol, or configured downlink time slot(s)/symbol(s) and/or flexible time slot(s)/symbol(s).

The configured downlink time slot/symbol is a time slot/symbol including the uplink part configured for a cell. For example, the time slot/symbol information including the uplink part (e.g., the time slot where the uplink subband is located (SlotULSubband)) is configured in the serving cell common configuration (ServingCellConfigCommon) and/or the serving cell configuration (ServingCellConfig). Furthermore, SlotULSubband is configured in TDD-UL-DL-ConfigCommon and/or TDD-UL-DL-ConfigDedicated. For example, the “nrofSBFDSymbols” parameter in the following parameters is the SlotULSubband configuration.

TDD-UL-DL-ConfigCommon information element

| | |
|---|---|
| TDD-UL-DL-ConfigCommon ::= | SEQUENCE { |
| referenceSubcarrierSpacing | SubcarrierSpacing, |
| pattern1 | TDD-UL-DL-Pattern, |
| pattern2 | TDD-UL-DL-Pattern |

}

| | |
|---|---|
| TDD-UL-DL-Pattern ::= | SEQUENCE { |
| dl-UL-TransmissionPeriodicity | ENUMERATED {ms0p5, ms0p625, ms1, |

ms1p25, ms2, ms2p5, ms5, ms10},

| | |
|---|---|
| nrofDownlinkSlots | INTEGER (0..maxNrofSlots), |
| nrofDownlinkSymbols | INTEGER (0..maxNrofSymbols-1), |
| nrofUplinkSlots | INTEGER (0..maxNrofSlots), |
| nrofUplinkSymbols | INTEGER (0..maxNrofSymbols-1), |
| nrofSBFDSymbols | INTEGER (0..maxNrofSymbols-1), |

...,
}
TDD-UL-DL-ConfigDedicated information element

| | |
|---|---|
| TDD-UL-DL-ConfigDedicated ::= | SEQUENCE { |
| slotSpecificConfigurationsToAddModList | SEQUENCE (SIZE |
| (1..maxNrofSlots)) OF TDD-UL-DL-SlotConfig | OPTIONAL, -- Need N |
| slotSpecificConfigurationsToReleaseList | SEQUENCE (SIZE (1..maxNrofSlots)) |
| OF TDD-UL-DL-SlotIndex | OPTIONAL, -- Need N |

...
}

| | |
|---|---|
| TDD-UL-DL-SlotConfig ::= | SEQUENCE { |
| slotIndex | TDD-UL-DL-SlotIndex, |
| symbols | CHOICE { |
| allDownlink | NULL, |
| allUplink | NULL, |
| explicit | SEQUENCE { |
| nrofDownlinkSymbols | INTEGER |

(1..maxNrofSymbols-1)

| | |
|---|---|
| nrofUplinkSymbols | INTEGER |

(1..maxNrofSymbols-1)

| | |
|---|---|
| nrofSBFDSymbols | INTEGER |

```
(0..maxNrofSymbols-1);
    }
  }
}
```

In an embodiment, the terminal device receives BWP-UplinkCommon and TDD-UL-DL-ConfigCommon.

BWP-UplinkCommon includes UL subband-r18. The configuration is as follows: UL subband-r18=501, and the BWP bandwidth is 50. It can be seen that the starting RB of the uplink part is 1 and the number of RBs is 11.

| BWP-UplinkCommon ::= | SEQUENCE { |
|---|---|
| ...... | |
| UL subband-r18 | 501 |

.......
}

In this example, TDD-UL-DL-ConfigCommon may include a TDD uplink and downlink pattern (TDD-UL-DL-Pattern), and the specific configuration is as follows: if nrofSBFDSymbols is 8, the UL subband will be applied to time slots 1 to 8 of each radio frame.

| TDD-UL-DL-ConfigCommon ::= | SEQUENCE { |
|---|---|
| referenceSubcarrierSpacing | SubcarrierSpacing, |
| pattern1 | TDD-UL-DL-Pattern, |
| pattern2 | TDD-UL-DL-Pattern |
| } | |
| TDD-UL-DL-Pattern ::= | SEQUENCE { |
| dl-UL-TransmissionPeriodicity | ms10, |
| nrofDownlinkSlots | 2, |
| nrofDownlinkSymbols | 0, |
| nrofUplinkSlots | 2, |
| nrofUplinkSymbols | 0, |
| nrofSBFD Symbols | 8, |

...,
}

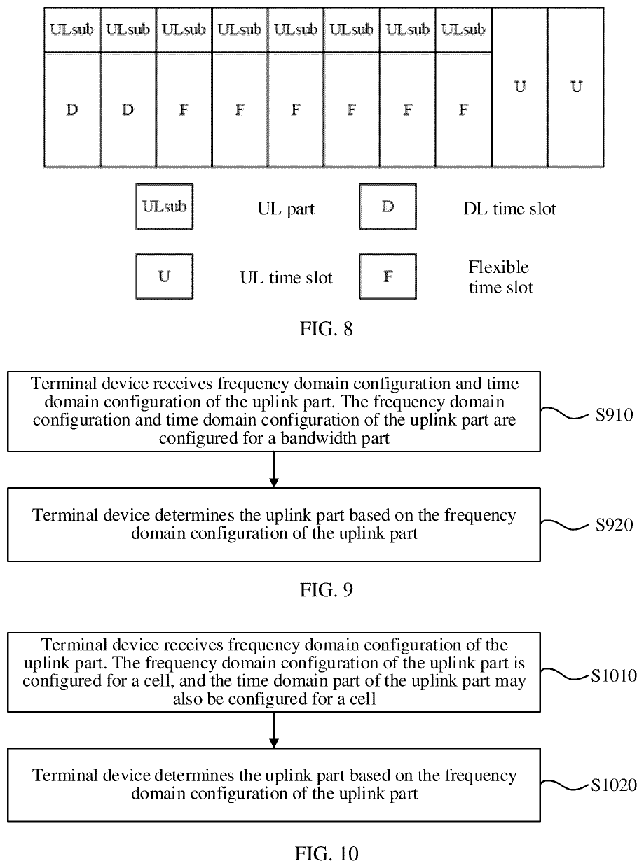

Based on BWP-UplinkCommon and TDD-UL-DL-ConfigCommon, the terminal device may obtain the uplink and downlink transmission directions as shown in FIG. 8. That is, there are 2 downlink time slots and 2 uplink time slots in a radio frame, and time slots 1 to 8 include the uplink part.

### Example 2: Semi-Statically Configure the Time-Frequency Domain Information of the Uplink Part, as Shown in FIG. 9

In S910, the terminal device receives frequency domain configuration and time domain configuration of the uplink part. The frequency domain configuration and time domain configuration of the uplink part are configured for a bandwidth part. Optionally, the terminal device may receive, from the network device, configuration including the frequency domain configuration and time domain configuration of the uplink part for BWP.

Furthermore, the frequency domain configuration of the uplink part is a parameter of the bandwidth part. For example, the frequency domain configuration of the uplink part (e.g., UL subband) indicates a section of continuous RB resources using a RIV manner. The RIV indication value is obtained by the indicated starting RB and the number of RBs. Furthermore, the UL subband indicated by the RIV is within the bandwidth part. That is, the bandwidth of the UL subband is less than or equal to the bandwidth of the bandwidth part.

Furthermore, the frequency domain configuration of the uplink part is a common configuration parameter for cells. For example, the frequency domain configuration of the uplink part (e.g., UL subband) is a parameter in BWP-UplinkCommon, or the frequency domain configuration of the uplink part is a parameter in BWP-DownlinkCommon. Since the SBFD operation is on the base station side, the division of the uplink and downlink parts is usually directly related to the RF implementation of the base station. The unified configuration is adopted by the entire cell, which may reduce the implementation complexity of the base station side.
(a) In a case where the UL subband is configured in BWP-UplinkCommon, the subcarrier spacing (subcarrierSpacing) and/or cyclic prefix (cyclicPrefix) used by the uplink part are determined by subcarrierSpacing and/or cyclicPrefix in BWP-UplinkCommon, respectively. Furthermore, subcarrierSpacing and/or cyclicPrefix used by the uplink part are the same as subcarrierSpacing and/or cyclicPrefix in BWP-DownlinkCommon respectively, which ensures time-frequency synchronization when the uplink and downlink occur in the same symbol. The subcarrier spacing (subcarrierSpacing) and/or cyclic prefix (cyclicPrefix) used by the uplink part may also be configured by subcarrierSpacing and/or cyclicPrefix dedicated to the UL subband.
(b) In a case where the UL subband is configured in BWP-DownlinkCommon, subcarrierSpacing and/or cyclicPrefix used by the uplink part are determined by subcarrierSpacing and/or cyclicPrefix in BWP-DownlinkCommon, respectively.

Of course, in order to adapt to the bandwidth capabilities and service requirements of different terminal devices, the uplink part may also be user dedicated configuration parameter. For example, the uplink part configuration (e.g., UL subband) is a parameter in BWP-UplinkDedicated, or the uplink part configuration is a parameter in BWP-DownlinkDedicated.

Furthermore, the time domain configuration of the uplink part is a parameter of the bandwidth part. For example, the time domain configuration of the uplink part indicates the time slot where the uplink subband is located (SlotULSubband). The time domain configuration of the uplink part may adopt a bitmap manner to indicate SlotULSubband in a cycle. For example, 1 indicates an SBFD time slot/symbol, and 0 indicates a non-SBFD time slot/symbol. The time domain configuration of the uplink part may also directly indicate the number of SBFD time slots/symbols, e.g., nrofSBFD. The symbols of the uplink part are adjacent to the uplink symbols.

Furthermore, the time domain configuration of the uplink part is a common configuration parameter for cells. For example, the time domain configuration of the uplink part (e.g., SlotULSubband) is a parameter in BWP-UplinkCommon, or the frequency domain configuration of the uplink part is a parameter in BWP-DownlinkCommon. Since the SBFD operation is on the base station side, the division of the uplink and downlink parts is usually directly related to the RF implementation of the base station. The unified configuration is adopted by the entire cell, which may reduce the implementation complexity of the base station side. Of course, in order to adapt to the bandwidth capabilities and service requirements of different terminal devices, the uplink part may also be user dedicated configuration parameter. For example, the time domain configuration of the uplink part (e.g., SlotULSubband) is a parameter in BWP-UplinkDedicated, or the uplink part configuration is a parameter in BWP-DownlinkDedicated.

When the BWP configuration changes, the uplink part configuration also changes accordingly. The uplink part configuration takes effect at the same time as the BWP configuration. For example, the terminal device receives two BWP configurations (e.g., a first BWP-UplinkCommon and a second BWP-UplinkCommon, and each BWP-UplinkCommon includes UL subband and SlotULSubband. When the terminal device indicates the first BWP-UplinkCommon, the terminal device determines the uplink part according to the UL subband and SlotULSubband in the first BWP-UplinkCommon. When the terminal device indicates the second BWP-UplinkCommon, the terminal device determines the uplink part according to the UL subband and SlotULSubband in the second BWP-UplinkCommon.

Furthermore, the terminal device receives the guard sideband configuration (e.g., guard band(s)). Guard sideband(s) is/are located on one or both sides of the uplink part. If the guard sidebands are located on both sides of the uplink part, bandwidths of the guard sidebands on both sides of the uplink part may be the same or different. The guard band may be just the number of RBs, or includes the starting RB and the number of RBs. In a case where the guard band only includes the number of RBs, the guard band is adjacent to the UL subband by default. In a case where the UL subband is located in the middle of the carrier, the guard bands are applied to both sides of the UL band, and the number of RBs of each of the guard bands on both sides is the same. In a case where the UL subband is located on one side of the carrier, the guard band is applied to the side of the UL subband close to the center frequency. Alternatively, two guard bands are configured to be located on both sides of the UL subband, respectively.

In S920, the terminal device determines the uplink part based on the frequency domain configuration of the uplink part.
(a) If UL subband and/or SlotULSubband are configured only in BWP-UplinkCommon, for at least one of the downlink time slot, downlink symbol, flexible time slot, and flexible symbol configured in step S910, the uplink part is determined according to the UL subband and/or SlotULSubband configuration in BWP-UplinkCommon.
(b) If UL subband and/or SlotULSubband are configured only in BWP-DownlinkCommon, for at least one of the downlink time slot, downlink symbol, flexible time slot, and flexible symbol configured in step S910, the uplink part is determined according to the UL subband and/or SlotULSubband configuration in BWP-DownlinkCommon.
(c) If UL subband and/or SlotULSubband are configured in BWP-DownlinkCommon and BWP-UplinkCommon, for the downlink time slot and/or downlink symbol configured in step S910, the uplink part is determined according to the UL subband and/or SlotULSubband configuration in BWP-DownlinkCommon; and for the flexible time slot and/or flexible symbol configured in step 910, the uplink part is determined according to the UL subband and/or SlotULSubband configuration in BWP-UplinkCommon.

Furthermore, BWP-UplinkCommon and BWP-DownlinkCommon may be replaced by BWP-UplinkDedicated and BWP-DownlinkDedicated in the above examples.

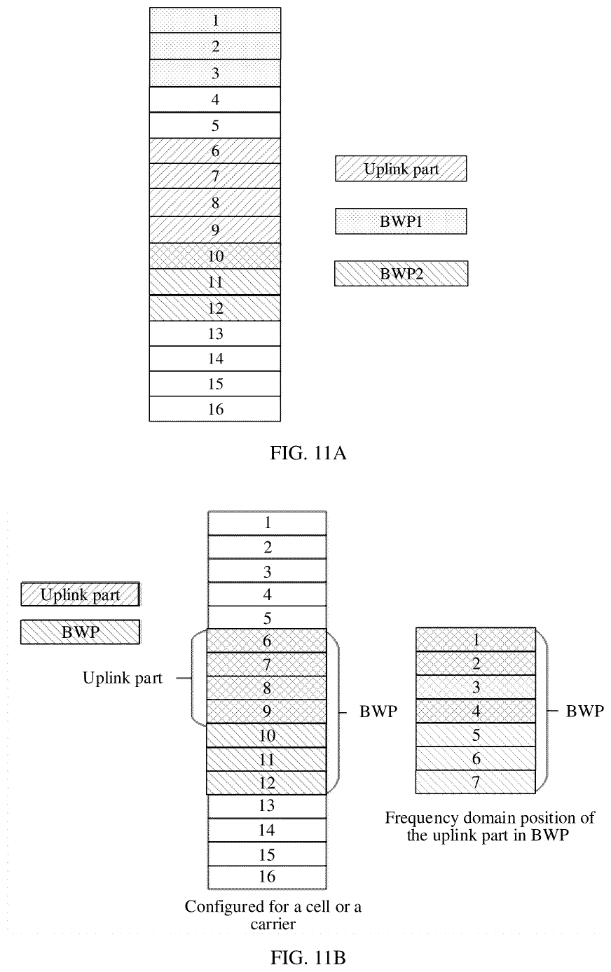

### Example 3: Frequency Domain Configuration of the Uplink Part Adopts Cell-Level Configuration, as Shown in FIG. 10

In S1010, the terminal device receives frequency domain configuration of the uplink part. The frequency domain configuration of the uplink part is configured for a cell, and the time domain part of the uplink part may also be configured for a cell. Optionally, the terminal device may receive, from the network device, configuration including the frequency domain configuration and time domain configuration of the uplink part for a cell.

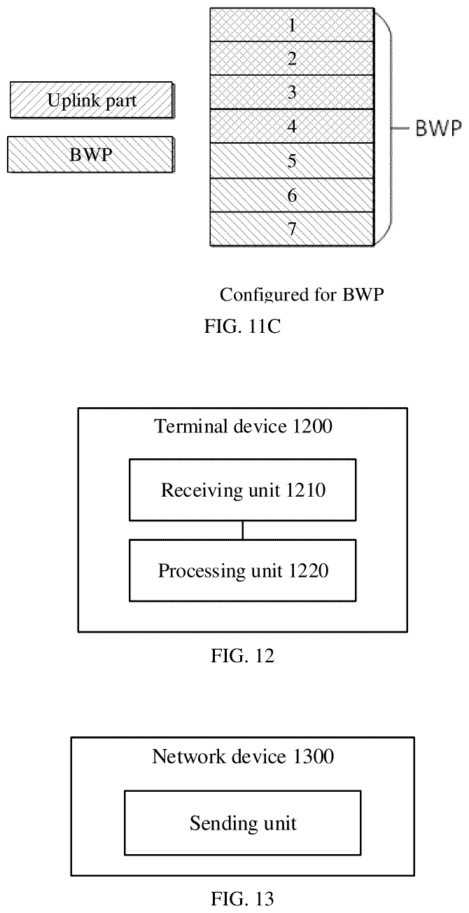

For example, the frequency domain configuration of the uplink part is indicated by a serving cell common configuration system information block (ServingCellConfigCommon System Information Block, ServingCellConfigCommonSIB) or a serving cell common configuration (ServingCellConfigCommon) information indication. Typically, the frequency domain configuration indicates a section of continuous RB resources using the RIV manner. The RIV indication value is obtained by the indicated starting RB and the number of RBs. As shown in FIG. 11a, the frequency domain configuration of the uplink part is RBs 6 to 10.

In S1020, the terminal device determines the uplink part based on the time domain configuration and frequency domain configuration of the uplink part.

For example, the terminal device determines whether the uplink part and/or the frequency domain position of the uplink part is included, according to the frequency domain configuration of the uplink part configured in ServingCellConfigCommonSIB or ServingCellConfigCommon and the current BWP configuration.

As shown in FIG. 11a, for BWP1, its frequency domain range RB {1,2,3} does not include the uplink part RB {6,7,8 . . . 10}; and thus, BWP1 in this time slot/symbol does not include the uplink part, and the transmission direction of the time slot/symbol is determined according to the uplink and downlink configuration and/or scheduling. For BWP2, its frequency domain range RB {10,11,12} includes the uplink part, and the uplink part is the first RB of BWP2, which corresponds to RB10 in FIG. 11a.

For another example, as shown in FIG. 11b, the BWP bandwidth is RB {6,7,8 . . . 12}. The uplink part is configured for a cell or a carrier, and the uplink part is configured as RB {6,7,8,9}. Based on the BWP bandwidth and the uplink part configuration, the frequency domain position of the uplink part in the current BWP is RB {1,2,3,4}. That is, when the uplink part is configured as RB {6,7,8,9} and the BWP bandwidth is RB {6,7,8, . . . 12}, the uplink part corresponds to RB {1,2,3,4} in BWP.

For another example, as shown in FIG. 11c, the uplink part is configured for BWP, and the uplink part is configured as RB {1,2,3,4}. That is, when the uplink part is configured as RB {1,2,3,4}, the uplink part corresponds to RB {1,2,3,4} in BWP.

FIG. 12 is a schematic block diagram of a terminal device 1200, in accordance with an embodiment of the present application. The terminal device 1200 may include:
a receiving unit 1210, configured to receive configuration information of a first part, the configuration information of the first part being configured for at least one of a bandwidth part (BWP), a cell or a carrier. The first part is determined based on the configuration information of the first part, a transmission direction of the first part is capable of being different from a transmission direction of a second part, and the first part and the second part are different frequency domain parts of a same time unit.

In an implementation, the terminal device 1200 may further include a processing unit 1220, configured to determine the first part based on the configuration information of the first part.

In an implementation, the configuration information of the first part includes frequency domain configuration information of the first part and/or time domain configuration information of the first part.

In an implementation, the frequency domain configuration information of the first part is configured for BWP, and the frequency domain configuration information of the first part is configured in BWP configuration information; and/or the time domain configuration information of the first part is configured for BWP, and the time domain configuration information of the first part is configured in the BWP configuration information.

In an implementation, the BWP configuration information includes uplink BWP configuration information and/or downlink BWP configuration information, and the configuration information of the first part is configured in the uplink BWP configuration information and/or the downlink BWP configuration information.

In an implementation, the configuration information of the first part is configured in BWP common configuration information or BWP user dedicated configuration information.

In an implementation, subcarrier spacing used by the first part is determined by the uplink BWP configuration information or the downlink BWP configuration information; and/or a cyclic prefix used by the first part is determined by the uplink BWP configuration information or the downlink BWP configuration information.

In an implementation, subcarrier spacing in the uplink BWP configuration information is the same as subcarrier spacing in the downlink BWP configuration information; and/or a cyclic prefix in the uplink BWP configuration information is the same as a cyclic prefix in the downlink BWP configuration information.

In an implementation, an indication manner of the frequency domain configuration information of the first part includes a resource indication value (RIV), a bitmap or a count.

In an implementation, a bandwidth of the first part is within a bandwidth of BWP.

In an implementation, the receiving unit 1210 is further configured to receive guard sideband configuration information; and the processing unit 1220 is further configured to determine a position of guard sideband(s) based on the guard sideband configuration information. The guard sideband(s) is/are located on one side or both sides of the first part.

In an implementation, in a case where the guard sidebands are located on both sides of the first part, bandwidths of the guard sidebands on both sides of the first part are the same or different.

In an implementation, in a case where there are downlink transmission resources on both sides of the first part within a carrier, the guard sidebands each are located between the first part and a downlink transmission resource, and the number of resource blocks (RBs) of each of the guard sidebands on both sides of the first part is the same.

In an implementation, in a case where there is a downlink transmission resource on only one side of the first part within a carrier, the guard sideband is located between the first part and the downlink transmission resource.

In an implementation, the frequency domain configuration information of the first part is applicable to at least one of the following:
all first time slots;
all first symbols;
a first time slot including the first part, agreed upon by a protocol;
a first symbol including the first part, agreed upon by a protocol;
a configured first time slot including the first part; or
a configured first symbol including the first part.

In an implementation, the first time slot includes a downlink time slot or a flexible time slot, and the first symbol includes a downlink symbol or a flexible symbol.

In an implementation, the frequency domain configuration information of the first part is configured for the cell or the carrier; and/or the time domain configuration information of the first part is configured for the cell or the carrier.

In an implementation, subcarrier spacing used by the first part is determined by activated uplink BWP configuration information or downlink BWP configuration information; and/or a cyclic prefix used by the first part is determined by the activated uplink BWP configuration information or downlink BWP configuration information.

In an implementation, a frequency domain position of the first part is obtained based on at least one of the following:
frequency domain configuration information of the first part in BWP configuration information; or
frequency domain configuration information in the BWP configuration information and the frequency domain configuration information of the first part.

In an implementation, in a case where the first part is configured, the configuration of BWP needs to meet at least one of the following:
that BWP only supports semi-static configuration, and a bandwidth of BWP includes a bandwidth of the first part; or
that bandwidths of all BWPs include a bandwidth of the first part.

In an implementation, the first part includes an uplink part or a downlink part.

In the embodiments of the present application, the terminal device 1200 may implement the corresponding functions of the terminal device in the method 300 in the above embodiments. For processes, functions, implementations and beneficial effects corresponding to various modules (sub-modules, units or components) in the terminal device 1200, reference can be made to the corresponding description in the above method embodiments, which will not be repeated here. It should be noted that functions described in each module (sub-module, unit or component) in the terminal device 1200 in the embodiments of the present application may be implemented by different modules (sub-modules, units or components) or by the same module (sub-module, unit or component).

FIG. 13 is a schematic block diagram of a network device 1300, in accordance with an embodiment of the present application. The network device 1300 may include:
a sending unit 1310, configured to send configuration information of a first part, the configuration information of the first part being configured for at least one of BWP, a cell, or a carrier.

The first part is determined based on the configuration information of the first part, a transmission direction of the first part is capable of being different from a transmission direction of a second part, and the first part and the second part are different frequency domain parts of a same time unit.

In an implementation, the network device 1300 may further include a determination unit (not shown in the figure), and the determination unit is configured to determine the configuration information of the first part.

In an implementation, the configuration information of the first part includes frequency domain configuration information of the first part and/or time domain configuration information of the first part.

In an implementation, the frequency domain configuration information of the first part is configured for BWP, and the frequency domain configuration information of the first part is configured in BWP configuration information; and/or the time domain configuration information of the first part is configured for BWP, and the time domain configuration information of the first part is configured in the BWP configuration information.

In an implementation, the BWP configuration information includes uplink BWP configuration information and/or downlink BWP configuration information, and the configuration information of the first part is configured in the uplink BWP configuration information and/or the downlink BWP configuration information.

In an implementation, the configuration information of the first part is configured in BWP common configuration information or BWP user dedicated configuration information.

In an implementation, subcarrier spacing used by the first part is determined by the uplink BWP configuration information or the downlink BWP configuration information; and/or a cyclic prefix used by the first part is determined by the uplink BWP configuration information or the downlink BWP configuration information.

In an implementation, subcarrier spacing in the uplink BWP configuration information is the same as subcarrier spacing in the downlink BWP configuration information; and/or a cyclic prefix in the uplink BWP configuration information is the same as a cyclic prefix in the downlink BWP configuration information.

In an implementation, an indication manner of the frequency domain configuration information of the first part includes a resource indication value (RIV), a bitmap or a count.

In an implementation, a bandwidth of the first part is within a bandwidth of BWP.

In an implementation, the sending unit 1310 is further configured to send guard sideband configuration information. A position of guard sideband(s) is determined based on the guard sideband configuration information. The guard sideband(s) is/are located on one side or both sides of the first part.

In an implementation, in a case where the guard sidebands are located on both sides of the first part, bandwidths of the guard sidebands on both sides of the first part are the same or different.

In an implementation, in a case where there are downlink transmission resources on both sides of the first part within a carrier, the guard sidebands each are located between the first part and a downlink transmission resource, and the number of resource blocks (RBs) of each of the guard sidebands on both sides of the first part is the same.

In an implementation, in a case where there is a downlink transmission resource on only one side of the first part within a carrier, the guard sideband is located between the first part and the downlink transmission resource.

In an implementation, the frequency domain configuration information of the first part is applicable to at least one of the following:
all first time slots;
all first symbols;
a first time slot including the first part, agreed upon by a protocol;
a first symbol including the first part, agreed upon by a protocol;
a configured first time slot including the first part; or
a configured first symbol including the first part.

In an implementation, the first time slot includes a downlink time slot or a flexible time slot, and the first symbol includes a downlink symbol or a flexible symbol.

In an implementation, the frequency domain configuration information of the first part is configured for the cell or the carrier; and/or the time domain configuration information of the first part is configured for the cell or the carrier.

In an implementation, subcarrier spacing used by the first part is determined by activated uplink BWP configuration information or downlink BWP configuration information; and/or a cyclic prefix used by the first part is determined by the activated uplink BWP configuration information or downlink BWP configuration information.

In an implementation, a frequency domain position of the first part is obtained based on at least one of the following:
frequency domain configuration information of the first part in the BWP configuration information; or
frequency domain configuration information in the BWP configuration information and the frequency domain configuration information of the first part.

In an implementation, in a case where the first part is configured, the configuration of BWP needs to meet at least one of the following:
that BWP only supports semi-static configuration, and a bandwidth of BWP includes a bandwidth of the first part; or
that bandwidths of all BWPs include a bandwidth of the first part.

In an implementation, the first part includes an uplink part or a downlink part.

In the embodiments of the present application, the network device 1300 may implement the corresponding functions of the network device in the method 500 in the above embodiments. For processes, functions, implementations and beneficial effects corresponding to various modules (sub-modules, units or components) in the network device 1300, reference can be made to the corresponding description in the above method embodiments, which will not be repeated here. It should be noted that functions described in each module (sub-module, unit or component) in the network device 1300 in the embodiments of the present application may be implemented by different modules (sub-modules, units or components) or by the same module (sub-module, unit or component).

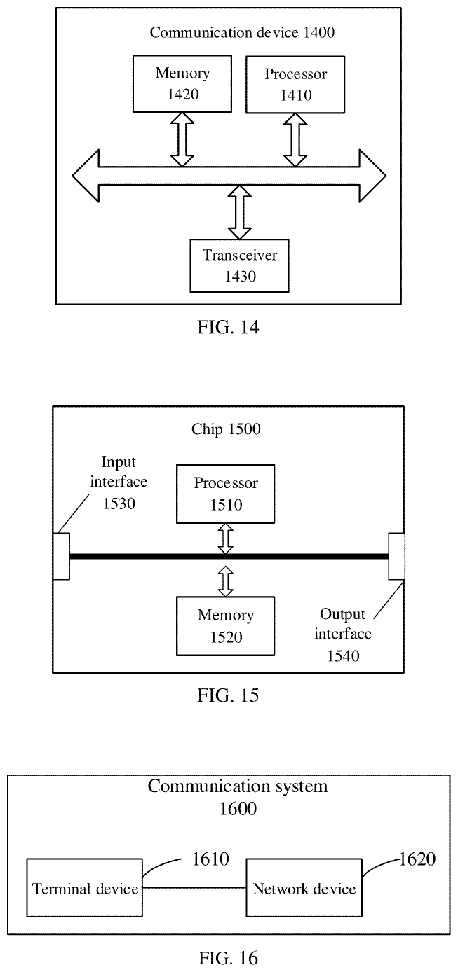

FIG. 14 is a schematic structural diagram of a communication device 1400, in accordance with embodiments of the present application. The communication device 1400 includes a processor 1410, and the process 1410 may call a computer program from a memory and run the computer program, to cause the communication device 1400 to perform the method in the embodiments of the present application. For example, in a terminal device, the processor 1410 includes the processing unit 1220 of the terminal device or is capable of implementing the functions and steps implemented by the processing unit 1220. For another example, in a network device, the processor 1410 includes the determination unit of the network device or is capable of implementing the functions and steps performed by the processing unit 1220.

In an implementation, the communication device 1400 may further include a memory 1420. The processor 1410 may call a computer program from the memory 1420 and run the computer program, to cause the communication device 1400 to perform the method in the embodiments of the present application.

The memory 1420 may be a separate device independent of the processor 1410, or may be integrated into the processor 1410.

In an implementation, the communication device 1400 may further include a transceiver 1430, and the processor 1410 may control the transceiver 1430 to communicate with other devices. Specifically, the processor 1410 may control the transceiver 1430 to send information or data to other devices, or to receive information or data sent by other devices. For example, in a terminal device, the transceiver 1430 includes the receiving unit 1210 of the terminal device or is capable of implementing the functions and steps implemented by the receiving unit 1210. For another example, in a network device, the transceiver 1430 includes the sending unit 1310 of the network device or is capable of implementing the functions and steps implemented by the sending unit 1310.

The transceiver 1430 may include a transmitter and a receiver. The transceiver 1430 may further include antennas, and the number of the antennas may be one or more.

In an implementation, the communication device 1400 may be the network device in the embodiments of the present application, and the communication device 1400 may implement the corresponding processes implemented by the network device in the methods in the embodiments of the present application, which will not be described in detail here for the sake of brevity.

In an implementation, the communication device 1400 may be the terminal device in the embodiments of the present application, and the communication device 1400 may implement the corresponding processes implemented by the terminal device in the methods in the embodiments of the present application, which will not be described in detail here for the sake of brevity.

FIG. 15 is a schematic structural diagram of a chip 1500, in accordance with embodiments of the present application. The chip 1500 includes a processor 1510, and the processor 1510 may call a computer program from a memory and run the computer program, to perform the method in the embodiments of the present application.

In an implementation, the chip 1500 may further include a memory 1520. The processor 1510 may call a computer program from the memory 1520 and run the computer program, to perform the method implemented by the terminal device or the network device in the embodiments of the present application.

The memory 1520 may be a separate device independent of the processor 1510, or may be integrated into the processor 1510.

In an implementation, the chip 1500 may further include an input interface 1530. The processor 1510 may control the input interface 1530 to communicate with other devices or chips. Specifically, the processor 1510 may control the input interface 1530 to obtain information or data sent by other devices or chips.

In an implementation, the chip 1500 may further include an output interface 1540. The processor 1510 may control the output interface 1540 to communicate with other devices or chips. Specifically, the processor 1510 may control the output interface 1540 to output information or data to other devices or chips.

In an implementation, the chip may be applied to the network device in the embodiments of the present application, and the chip may implement the corresponding processes implemented by the network device in the methods in the embodiments of the present application, which will not be described in detail here for the sake of brevity.

In an implementation, the chip may be applied to the terminal device in the embodiments of the present application, and the chip may implement the corresponding processes implemented by the terminal device in the methods in the embodiments of the present application, which will not be described in detail here for the sake of brevity.

The chips applied to the network device and the terminal device may be the same or different.

It should be understood that the chip mentioned in the embodiments of the present application may also be referred to as a system-level chip, a system chip, a chip system or a system-on-chip chip.

The processor mentioned above may be a general-purpose processor, a digital signal processor (DSP), a field programmable gate array (FPGA), an application specific integrated circuit (ASIC) or another programmable logic device, a transistor logic device, a discrete hardware component, or the like. The general-purpose processor mentioned above may be a microprocessor or any conventional processor.

The memory mentioned above may be a volatile memory or a non-volatile memory, or may include both volatile and non-volatile memories. The non-volatile memory may be a read-only memory (ROM), a programmable ROM (PROM), an erasable PROM (EPROM), an electrically EPROM (EEPROM), or a flash memory. The volatile memory may be a random access memory (RAM).

It should be understood that the above memories are exemplary but are not limiting illustration. For example, the memory in the embodiments of the present application may also be a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (synch link DRAM, SLDRAM), or a direct rambus RAM (DR RAM). That is, the memories in the embodiments of the present application are intended to include, but are not limited to, these and any other suitable types of memories.

FIG. 16 is a schematic block diagram of a communication system 1600, in accordance with embodiments of the present application. The communication system 1600 includes a terminal device 1610 and a network device 1620.

The network device 1620 is configured to send configuration information of a first part, where the configuration information of the first part is configured for at least one of a bandwidth part (BWP), a cell, or a carrier.

The terminal device 1610 is configured to receive the configuration information of the first part, where the first part is determined based on the configuration information of the first part, a transmission direction of the first part is capable of being different from a transmission direction of a second part, and the first part and the second part are different frequency domain parts of a same time unit.

The terminal device 1610 may be used to implement the corresponding functions implemented by the terminal device in the above method, and the network device 1620 may be used to implement the corresponding functions implemented by the network device in the above method, which will not be described in detail here for the sake of brevity.

In the above embodiments, all or part of them may be implemented by software, hardware, firmware or any combination thereof. When implemented using software, all or part of the above embodiments may be implemented in the form of a computer program product. The computer program product includes one or more computer instructions. When the computer program instruction(s) are loaded and executed on a computer, the processes or functions described in the embodiments of the present application are generated in whole or in part. The computer may be a general-purpose computer, a special purpose computer, a computer network, or any other programmable device. The computer instruction(s) may be stored in a non-transitory computer-readable storage medium, or transmitted from a non-transitory computer-readable storage medium to another non-transitory computer-readable storage medium. For example, the computer instruction(s) may be transmitted from a website, computer, server, or data center to another website, computer, server, or data center via a wired manner (e.g., a coaxial cable, an optical fiber, or a digital subscriber line (DSL)) or a wireless manner (e.g., infrared, wireless, or microwave). The non-transitory computer-readable storage medium may be any available medium that can be read by a computer, or may be a data storage device that includes one or more available medium, such as a server or a data center. The available medium may be a magnetic medium (e.g., a floppy disk, a hard disk, or a magnetic tape), an optical medium (e.g., a digital video disc (DVD)), or a semiconductor medium (e.g., a solid state disk (SSD)).

It should be understood that, in the various embodiments of the present application, the size of the serial numbers of the above processes does not mean the execution order. The execution order of the processes should be determined by their functions and internal logic, and should not constitute any limitation on the implementation process of the embodiments of the present application.

Those skilled in the art may clearly understand that, for convenience and conciseness of description, the working processes of the system, devices and units described above may refer to the corresponding processes in the above method embodiments, which will not be repeated here.

The above description is only implementation of the present application, but the protection scope of the present application is not limited thereto. Any person skilled in the art may readily conceive of variations or substitutions within the technical scope disclosed in the present application, which should be included within the protection scope of the present application. Therefore, the protection scope of the present application shall be subject to the protection scope of the claims.

What is claimed is:

1. A communication method, comprising:
receiving, by a terminal device, configuration information of a first part, the configuration information of the first part being configured for at least one of a bandwidth part (BWP), a cell, or a carrier;
wherein the first part is determined based on the configuration information of the first part, a transmission direction of the first part is capable of being different from a transmission direction of a second part, and the first part and the second part are different frequency domain parts of a same time unit.

2. The method according to claim 1, wherein the configuration information of the first part comprises frequency domain configuration information of the first part and/or time domain configuration information of the first part.

3. The method according to claim 1, wherein the configuration information of the first part is configured in BWP common configuration information or BWP user dedicated configuration information;
wherein
subcarrier spacing used by the first part is determined by the uplink BWP configuration information or the downlink BWP configuration information; and/or
a cyclic prefix used by the first part is determined by the uplink BWP configuration information or the downlink BWP configuration information.

4. The method according to claim 1, wherein the method further comprises:
receiving, by the terminal device, guard sideband configuration information, wherein a position of guard sideband(s) is determined based on the guard sideband configuration information, and the guard sideband(s) is/are located on one side or both sides of the first part.

5. The method according to claim 1, wherein
frequency domain configuration information of the first part is configured for the cell or the carrier; and/or
time domain configuration information of the first part is configured for the cell or the carrier.

6. The method according to claim 5, wherein
subcarrier spacing used by the first part is determined by activated uplink BWP configuration information or downlink BWP configuration information; and/or
a cyclic prefix used by the first part is determined by the activated uplink BWP configuration information or downlink BWP configuration information.

7. The method according to claim 1, wherein a frequency domain position of the first part is obtained based on at least one of the following:
frequency domain configuration information of the first part in BWP configuration information; or
frequency domain configuration information in the BWP configuration information and frequency domain configuration information of the first part.

8. The method according to claim 1, wherein the first part comprises an uplink part or a downlink part.

9. A terminal device, comprising a processor and a memory, wherein the memory is configured to store a computer program, and the processor is configured to call and run the computer program stored in the memory, to cause the terminal device to perform:
receiving configuration information of a first part, the configuration information of the first part being configured for at least one of a bandwidth part (BWP), a cell, or a carrier;
wherein the first part is determined based on the configuration information of the first part, a transmission direction of the first part is capable of being different from a transmission direction of a second part, and the first part and the second part are different frequency domain parts of a same time unit.

10. The terminal device according to claim 9, wherein the configuration information of the first part comprises frequency domain configuration information of the first part and/or time domain configuration information of the first part.

11. The terminal device according to claim 9, wherein the configuration information of the first part is configured in BWP common configuration information or BWP user dedicated configuration information; and
the processor is configured to call and run the computer program stored in the memory, to cause the terminal device to further perform:
receiving guard sideband configuration information, wherein a position of guard sideband(s) is determined based on the guard sideband configuration information, and the guard sideband(s) is/are located on one side or both sides of the first part.

12. The terminal device according to claim 9, wherein
frequency domain configuration information of the first part is configured for the cell or the carrier; and/or
time domain configuration information of the first part is configured for the cell or the carrier.

13. The terminal device according to claim 12, wherein
subcarrier spacing used by the first part is determined by activated uplink BWP configuration information or downlink BWP configuration information; and/or
a cyclic prefix used by the first part is determined by the activated uplink BWP configuration information or downlink BWP configuration information.

14. The terminal device according to claim 9, wherein a frequency domain position of the first part is obtained based on at least one of the following:
frequency domain configuration information of the first part in BWP configuration information; or
frequency domain configuration information in the BWP configuration information and frequency domain configuration information of the first part;
wherein the first part comprises an uplink part or a downlink part.

15. A network device, comprising a processor and a memory, wherein the memory is configured to store a computer program, and the processor is configured to call and run the computer program stored in the memory, to cause the network device to perform:
sending configuration information of a first part, the configuration information of the first part being configured for at least one of a bandwidth part (BWP), a cell, or a carrier;
wherein the first part is determined based on the configuration information of the first part, a transmission direction of the first part is capable of being different from a transmission direction of a second part, and the first part and the second part are different frequency domain parts of a same time unit.

16. The network device according to claim 15, wherein the configuration information of the first part comprises frequency domain configuration information of the first part and/or time domain configuration information of the first part.

17. The network device according to claim 15, wherein the configuration information of the first part is configured in BWP common configuration information or BWP user dedicated configuration information; and
the processor is configured to call and run the computer program stored in the memory, to cause the network device to further perform:
sending guard sideband configuration information, wherein a position of guard sideband(s) is determined based on the guard sideband configuration information, and the guard sideband(s) is/are located on one side or both sides of the first part.

18. The network device according to claim 15, wherein
frequency domain configuration information of the first part is configured for the cell or the carrier; and/or
time domain configuration information of the first part is configured for the cell or the carrier.

19. The network device according to claim 18, wherein
subcarrier spacing used by the first part is determined by activated uplink BWP configuration information or downlink BWP configuration information; and/or
a cyclic prefix used by the first part is determined by the activated uplink BWP configuration information or downlink BWP configuration information.

20. The network device according to claim 15, wherein a frequency domain position of the first part is obtained based on at least one of the following:
frequency domain configuration information of the first part in BWP configuration information; or
frequency domain configuration information in the BWP configuration information and frequency domain configuration information of the first part;
wherein the first part comprises an uplink part or a downlink part.
